(19) United States
(12) Patent Application Publication
(10) Pub. No.: US 2017/0326584 A1
(43) Pub. Date: Nov. 16, 2017

(54) ARTICLE AND METHOD FOR MAKING AND USING SAME

(71) Applicant: SAINT-GOBAIN PERFORMANCE PLASTICS CORPORATION, Solon, OH (US)

(72) Inventors: Heidi Lennon, Shrewsbury, MA (US); Charles S. GOLUB, Westford, MA (US); Brian J. WARD, Taunton, MA (US)

(21) Appl. No.: 15/591,965

(22) Filed: May 10, 2017

Related U.S. Application Data
(60) Provisional application No. 62/334,162, filed on May 10, 2016.

(51) Int. Cl. B05D 3/06; B05D 3/14; C08K 9/06; C09D 183/04

(52) U.S. Cl. CPC B05D 3/067; C09D 183/04; B05D 3/147; C08K 9/06

(57) ABSTRACT

An article includes a first portion including a silicone polymer; a second portion adjacent to the first portion, wherein the second portion includes a thermoplastic polymer including a functional moiety that forms a chemical bond with the silicone polymer. A method of forming an article includes providing a first portion including a silicone polymer; providing a second portion adjacent to the first portion, wherein the second portion includes a thermoplastic polymer including a functional moiety that forms a chemical bond with the silicone polymer; and curing the first portion at a temperature lower than the heat deformation temperature of the thermoplastic polymer to form the chemical bond between the functional moiety of the second portion and the silicone polymer of the first portion.

### CROSS-REFERENCE TO RELATED APPLICATION(S)

This application claims priority under 35 U.S.C. §119(e) to U.S. Patent Application No. 62/334,162 entitled “ARTICLE AND METHOD FOR MAKING AND USING SAME,” by Heidi Lennon, Charles S. Golub and Brian J. Ward, filed May 10, 2016, which is assigned to the current assignee hereof and incorporated herein by reference in its entirety.

### FIELD OF THE DISCLOSURE

The disclosure, generally, is related to an article and method of forming the article.

### BACKGROUND

Many industries utilize silicone materials for many applications because silicone is non-toxic, flexible, thermally stable, and has low chemical reactivity when compared with other materials. For example, silicone articles may be used in a variety of industries such as the medical industry, pharmaceutical industry, food delivery, and the like. In many instances, silicone materials are used in conjunction with thermoplastic elastomers in order to take advantage of the different properties provided by the thermoplastic elastomers. For example, thermoplastic elastomers are desirable for their permeation rates, low coefficient of friction, and low tack; however, thermoplastic elastomers are not ideal for processing or performance.

Composite articles may include a portion of a silicone material and a portion of a thermoplastic elastomer. However, composite articles are typically formed by heat curing silicone materials at an elevated temperature. For instance, temperatures in excess of at least 150° C., such as at least 160° C., such as at least 170° C., or even up to or greater than 200° C., are used for the heat cure. Due to the elevated temperature needed for heat cure, silicone materials have typically been commercially used with high melt temperature substrates for multiple component articles. These articles are typically expensive since they are limited to high melt temperature substrates. Unfortunately, adhesion between dissimilar materials such as silicone materials and thermoplastic elastomers can also be problematic, such that adhesion promoters, primers, chemical surface treatments, or even mechanical treatments must be used to provide the adhesion required for specific applications.

Accordingly, an improved multi-component article and method to form an article are desired.

### SUMMARY

In an embodiment, an article includes a first portion including a silicone polymer; a second portion adjacent to the first portion, wherein the second portion includes a thermoplastic polymer including a functional moiety that forms a chemical bond with the silicone polymer.

In another embodiment, a method of forming an article includes providing a first portion including a silicone polymer; providing a second portion adjacent to the first portion, wherein the second portion includes a thermoplastic polymer including a functional moiety that forms a chemical bond with the silicone polymer; and curing the first portion at a temperature lower than the heat deformation temperature of the thermoplastic polymer to form the chemical bond between the functional moiety of the second portion and the silicone polymer of the first portion.

### BRIEF DESCRIPTION OF THE DRAWINGS

The present disclosure may be better understood, and its numerous features and advantages made apparent to those skilled in the art by referencing the accompanying drawings.

FIG. 1 is a graphical depiction of the adhesion results showing the affect of a functional copolymer between an exemplary thermoplastic layer including a functionalized filler and a liquid silicone rubber layer.

FIG. 2 is a graphical depiction of the adhesion results showing the affect of a functional copolymer between exemplary thermoplastic layer including a functionalized filler and a liquid silicone rubber layer.

FIG. 3 is graphical depiction of the adhesion results showing the affect of a functionalized filler between an exemplary thermoplastic layer and a liquid silicone rubber layer.

FIG. 4 is graphical depiction of the adhesion results showing the affect of a functionalized filler between an exemplary thermoplastic layer and a liquid silicone rubber layer.

FIG. 5 is a graphical depiction of adhesion results before and after plasma treatment.

FIG. 6 is XPS analysis of CHx on the surface.

FIG. 7 is XPS analysis of C═O.

FIG. 8 is XPS analysis for Oxygen.

FIG. 9 is XPS analysis showing Amide functionality.

FIG. 10 is XPS analysis showing O—C═O functionality.

The use of the same reference symbols in different drawings indicates similar or identical items.

### DETAILED DESCRIPTION

The following description in combination with the figures is provided to assist in understanding the teachings disclosed herein. The following discussion focuses on specific implementations and embodiments of the teachings. This focus is provided to assist in describing the teachings and should not be interpreted as a limitation on the scope or applicability of the teachings.

As used herein, the terms “comprises,” “comprising,” “includes,” “including,” “has,” “having” or any other variation thereof, are open-ended terms and should be interpreted to mean “including, but not limited to . . . .” These terms encompass the more restrictive terms “consisting essentially of” and “consisting of.” In an embodiment, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in reference books and other sources within the structural arts and corresponding manufacturing arts. Unless indicated otherwise, all measurements are at about 77° F. (25° C.). For instance, values for viscosity are at 77° F. (25° C.), unless indicated otherwise.

The disclosure generally relates to an article, and in particular, to an article including a first portion and a second portion. The first portion includes a silicone polymer. The article further includes a second portion adjacent to the first portion, wherein the second portion includes a thermoplastic polymer. The second portion has increased adhesion to the silicone polymer of the first portion. In an embodiment, the second portion includes the thermoplastic polymer including a functional moiety that forms a chemical bond with the silicone polymer. In an embodiment, the functional moiety includes a functionalized filler, a functional thermoplastic polymer, or combination thereof. In a more particular embodiment, the functional thermoplastic polymer includes a grafted functional group on the thermoplastic polymer, i.e. “a grafted functionalized thermoplastic polymer”, a functionalized thermoplastic copolymer, or combination thereof. The first portion and the second portion have an advantageous adhesion between the two portions without the need for a separate primer layer or an adhesion promoter at an interface of the two portions.

In an embodiment, the first portion includes a silicone polymer. Any reasonable silicone polymer is envisioned. The silicone polymer may, for example, include polyalkylsiloxanes, such as silicone polymers formed of a precursor, such as dimethylsiloxane, diethylsiloxane, dipropylsiloxane, methylethylsiloxane, methylpropylsiloxane, or combinations thereof. In a particular embodiment, the polyalkylsiloxane includes a polydialkylsiloxane, such as polydimethylsiloxane (PDMS). In a particular embodiment, the polyalkylsiloxane is a silicone hydride-containing polyalkylsiloxane, such as a silicone hydride-containing polydimethylsiloxane. In a further embodiment, the polyalkylsiloxane is a vinyl-containing polyalkylsiloxane, such as a vinyl-containing polydimethylsiloxane. In yet another embodiment, the silicone polymer is a combination of a hydride-containing polyalkylsiloxane and a vinyl-containing polyalkylsiloxane, such as a combination of hydride-containing polydimethylsiloxane and a vinyl-containing polydimethylsiloxane. In an example, the silicone polymer is non-polar and is free of halide functional groups, such as chlorine and fluorine, and of phenyl functional groups. Alternatively, the silicone polymer may include halide functional groups or phenyl functional groups. For example, the silicone polymer may include fluorosilicone or phenylsilicone.

The silicone polymer further includes a catalyst. Typically, the catalyst is present to initiate the crosslinking process. Any reasonable catalyst that can initiate crosslinking at a temperature lower than a heat deformation temperature of the thermoplastic polymer is envisioned. “Heat deformation temperature” as used herein refers to the temperature at which the thermoplastic deforms under a specified load and is typically measured by deflection temperature under load (DTUL), measured by ASTM D648 or ISO 75. Typically, the catalyst is dependent upon the silicone polymer. In a particular embodiment, the catalytic reaction includes aliphatically unsaturated groups reacted with Si-bonded hydrogen in order to convert the addition-crosslinkable silicone material into the elastomeric state by formation of a network.

In an embodiment, the catalyst initiates crosslinking when exposed to a radiation source, such as ultraviolet radiation. In an embodiment, a hydrosilylation reaction catalyst may be used. For instance, an exemplary hydrosilylation catalyst is an organometallic complex compound of a transition metal. In an embodiment, the catalyst includes platinum, rhodium, ruthenium, the like, or combinations thereof. In a particular embodiment, the catalyst includes platinum. Further, any reasonable optional catalyst may be used with the hydrosilylation catalyst. In an embodiment, the optional catalyst may or may not initiate crosslinking when exposed to a radiation source. For instance, the optional catalyst may be thermally activated, with the proviso that it is thermally activated at a temperature lower than the heat deformation temperature of the thermoplastic polymer. Exemplary optional catalysts may include peroxide, tin, or combinations thereof. Alternatively, the silicone material further includes a peroxide catalyzed silicone material. In another example, the silicone material may be a combination of a platinum catalyzed and peroxide catalyzed silicone material.

The silicone polymer may further include any reasonable additive. Any reasonable additive is envisioned. Exemplary additives may include, either singly or in combination, a vinyl polymer, a hydride, an adhesion promoter, a filler, an initiator, an inhibitor, a colorant, a pigment, a carrier material, or any combination thereof. Any reasonable adhesion promoter that promotes adhesion of the silicone material to the layer it is directly in contact with is envisioned and is dependent upon the silicone material. In an embodiment, the adhesion promoter may include a siloxane or a silane, such as 3-methacryloxypropyltrimethoxysilane, 3-glycidoxypropyltrimethoxysilane, vinyl-tris(2-methoxyethoxy)-silane; 2,5,7,10-tetraoxa-6-silaundecane, 6-ethenyl-6-(2-methoxyethoxy)-silane, or any combination thereof. In an embodiment the first portion is substantially free of an adhesion promoter. “Substantially free” as used herein refers to less than about 0.1% by weight of any adhesion promoter, based on the total weight of the silicone polymer of the first portion. In an embodiment, the material content of the first portion is essentially 100% silicone material. In some embodiments, the first portion consists essentially of the respective silicone polymer described above. As used herein, the phrase “consists essentially of” used in connection with the silicone polymer precludes the presence of non-silicone polymers that affect the basic and novel characteristics of the silicone polymer, although, commonly used processing agents and additives may be used in the silicone polymer.

In a particular embodiment, the first portion may include a conventional, commercially prepared silicone polymer. The commercially prepared silicone polymer typically includes components such as the non-polar silicone polymer, the catalyst, a filler, and optional additives. Commercially available silicone polymers include, for example, a high consistency gum rubber (HCR), a liquid silicone rubber (LSR), or a room temperature vulcanizing silicone (RTV).

The article further includes a second portion. The second portion includes a thermoplastic polymer including a functional moiety that provides increased adhesion to the silicone polymer of the first portion. In an embodiment, the functional moiety includes a functionalized filler, a functional thermoplastic polymer, or combination thereof. In a more particular embodiment, the functionalized filler includes a base filler that has a functional moiety that forms a chemical bond with the silicone polymer of the first portion. Any reasonable base filler is envisioned such as a silica filler, fumed silica filler, quartz, glass filler, aluminum (AlO(OH)), alumino-silicate, inorganic oxides, resinous filler, carbon black, graphite, graphene, carbon nanotube (CNT), fullerene or combination thereof. In a particular embodiment, the functionalized filler includes a silica filler. Any functional moiety is envisioned that has an adhesive affinity to the silicone polymer. The functionalized moiety is, for example, a silane attached to the base filler, wherein the silane includes an acryl functional group, an epoxy functional group, a chloro functional group, or combination thereof. In an embodiment, any reasonable silane is envisioned and includes, for example, an alkoxysilane such as a trimethoxysilane, a triethoxysilane, or combination thereof. In an embodiment, the functionalized filler is a silicone-hydride attached to the base filler. In a particular embodiment, the silicone-hydride is trimethylsiloxy-terminated. When present as the functional moiety, any reasonable amount of functionalized filler is envisioned in the thermoplastic polymer to provide an adhesive bond with the silicone polymer. In an embodiment, the functionalized filler forms a cohesive bond with the silicone polymer, i.e. cohesive failure occurs wherein the structural integrity of the first portion and/or the second portion fails before the bond between the two materials fails. An exemplary amount of functionalized filler is at least about 0.1% by weight, such as about 0.1% by weight to about 35% by weight, or even about 0.1% by weight to about 20% by weight, based on the total amount of the thermoplastic polymer. In an exemplary embodiment, the functionalized filler is mixed with the thermoplastic polymer to form a homogenous mixture of the functionalized filler contained with a matrix of the thermoplastic polymer. In an embodiment, the functionalized filler may or may not form a reactive and covalent bond with the thermoplastic polymer. In a more particular embodiment, the functionalized filler does not form a reactive and covalent bond with the thermoplastic polymer.

The second portion includes the thermoplastic polymer. Any reasonable thermoplastic polymer is envisioned. In an embodiment, the thermoplastic polymer is a thermoplastic elastomer, a polyester, a polyurethane, a nylon, a polyimide, a polyamide, a polyether, a polystyrene, an acrylonitrile butadiene styrene (ABS), a polybutylene terephthalate (PBT), a polyacrylic, a polyester copolymer, an ethylene vinyl alcohol (EVOH), a polyolefin, a copolymer, a blend, or combination thereof. In a more particular embodiment, the thermoplastic polymer is a polyolefin such as a metallocene polyolefin or a Ziegler-Natta polyolefin. In a particular embodiment, the thermoplastic polymer has a heat deformation temperature of not greater than about 350° F. In an embodiment, the thermoplastic polymer has a Tg (glass transition temperature) of less than room temperature, for example, less than about 77° F.

In an embodiment, the thermoplastic polymer may be a functional thermoplastic polymer. In a particular embodiment, the functional thermoplastic polymer includes a grafted functional group on the thermoplastic polymer, a functionalized thermoplastic copolymer, or combination thereof. “Grafted” as used herein refers to a chemical group that is covalently bonded to the thermoplastic polymer. Any grafted functional group is envisioned that can form a bond with the silicone polymer such as, for example, an epoxy group, a vinyl alcohol, a vinyl butyrate, a vinyl chloride, a maleic anhydride, a vinyl copolymer, a methacrylate, a nucleophile, or combination thereof. In a particular embodiment, the grafted functional group forms an adhesive bond, and in a more particular embodiment, a cohesive bond with the silicone polymer. When present, any amount of grafted functional group on the thermoplastic polymer is envisioned to form a cohesive bond with the adhesion promoter. In an embodiment, the grafted functional group is a portion of a backbone of the thermoplastic polymer, a pendant group off of the backbone of the thermoplastic polymer, or combination thereof. In an embodiment, the grafted functional group is present at an amount of at least about 0.5% by weight of the thermoplastic polymer. In an embodiment, the thermoplastic polymer does not contain a grafted functional group.

In an embodiment, the functional thermoplastic polymer is a functionalized thermoplastic copolymer. “A functionalized thermoplastic copolymer” includes a thermoplastic polymer co-polymerized with a polymer having at least one functional group that forms an adhesive bond, and in a more particular embodiment, a cohesive bond with the silicone polymer. Any polymer with at least one functional group is envisioned. In an embodiment, the functionalized thermoplastic copolymer includes a thermoplastic polymer copolymerized with an epoxy based compound, a polycarbodiimide based compound, a phosphite containing compound, a hindered phenol, a bi-cyclic-imino ether, a bi-cyclic-imino ester, a hindered amine, a 2,2′-bis(2-oxazoline) based molecule, an isocyanate, a di-isocyanate, or a combination thereof. In an example, the thermoplastic polymer and functional group includes an ethylene copolymer and terpolymers with glycidyl methacrylate as a reactive site with an epoxy group. For instance, the thermoplastic polymer is co-polymerized with an ethylene copolymer and terpolymers with glycidyl methacrylate. In an embodiment, the polymer with at least one functional group is a portion of a backbone of the thermoplastic polymer, a pendant group off of the backbone of the thermoplastic polymer, or combination thereof. Any amount of polymer with at least one functional group copolymerized with the thermoplastic polymer is envisioned to form a cohesive bond with the adhesion promoter. In an embodiment, the copolymer is at least 1% by weight of the functional thermoplastic polymer. In an embodiment, the thermoplastic polymer is not co-polymerized with a polymer having at least one functional group capable of forming an adhesive bond with the silicone polymer.

The second portion may be formed with any reasonable component such as any thermoplastic polymer precursor with the optional addition of any catalyst, any filler, any additive, any crosslink promoter, or combination thereof. The thermoplastic polymer precursor is dependent upon the final thermoplastic polymer desired. In an embodiment, the crosslink promoter may be triallyl cyanurate (TAC), triallyl isocyanurate (TAIC), or combination thereof. When present, any reasonable catalyst is envisioned that can initiate crosslinking of the functionalized filler and/or the functional thermoplastic polymer to the silicone polymer. In an embodiment, the catalyst is activated by a radiation source. In a particular embodiment, the catalyst has a degradation temperature greater than the processing temperature (i.e. melt temperature) of the thermoplastic polymer such that the catalyst does not activate during the melting of the thermoplastic material. An exemplary catalyst is a peroxide. In a particular embodiment, the precursor, the catalyst, the filler, the additive, the crosslink promoter, or combination thereof are dependent upon the thermoplastic polymer chosen and final properties desired for the article. In an embodiment, the thermoplastic polymer of the second portion is substantially free of a silicone moiety on the backbone of the thermoplastic polymer. In an embodiment, the thermoplastic polymer of the second portion is substantially free of a catalyst, an additional crosslink promoter, or combination thereof. “Substantially free” as used herein refers to less than about 0.1% by weight of any catalyst, any additional crosslink promoter, or combination thereof, based on the total weight of the thermoplastic polymer of the second portion.

In an even more particular embodiment, the functionalized filler and/or the functional thermoplastic polymer is crosslinked to the silicone polymer at a temperature less than the heat deflection temperature of the thermoplastic polymer, such as via a radiation source. The source of radiation energy can include any reasonable radiation energy source such as actinic radiation. In a particular embodiment, the radiation source is ultraviolet light. Any reasonable wavelength of ultraviolet light is envisioned. In a specific embodiment, the ultraviolet light is at a wavelength of about 10 nanometers to about 410 nanometers. Further, any number of applications of radiation energy may be applied with the same or different wavelengths, depending upon the material and the desired result. It will be appreciated that the wavelength can be within a range between any of the minimum and maximum values noted above.

In an embodiment, the material content of the second portion is essentially 100% thermoplastic polymer and functionalized filler. In some embodiments, the second portion consists essentially of the respective thermoplastic polymer and functionalized filler. In an embodiment, the second portion consists essentially of the respective thermoplastic polymer, functionalized filler, and a catalyst as described. In some embodiments, the second portion consists essentially of the functional thermoplastic polymer including a grafted functional group on the thermoplastic polymer, a functionalized thermoplastic copolymer, or combination thereof. In yet another embodiment, the second portion consists essentially of the functional thermoplastic polymer and a catalyst. In an embodiment, the second portion consists essentially of the functional thermoplastic polymer and functionalized filler. In yet another embodiment, the second portion consists essentially of the functional thermoplastic polymer, functionalized filler, and a catalyst. As used herein, the phrase “consists essentially of” used in connection with the thermoplastic material precludes the presence of materials that affect the basic and novel characteristics of the thermoplastic polymer, although, commonly used processing agents and additives may be used in the thermoplastic polymer.

Although described as two portions, any number of portions is envisioned. For instance, the article includes at least three portions, or even a greater number of portions. The number of portions is dependent upon the final properties desired for the article. The article may further include other portions. Other portions include, for example, a polymeric portion, a reinforcing portion, an adhesive portion, a barrier portion, a chemically resistant portion, a metal portion, any combination thereof, and the like. Any reasonable method of providing any additional portion is envisioned and is dependent upon the material chosen. Any dimension of the other portions may be envisioned. In an embodiment, the article consists essentially of the first portion and the second portion as described.

In an embodiment, the article may be formed by any reasonable means and is dependent upon the material. In an example, the first portion of the silicone polymer is provided by any reasonable means. In an embodiment, the silicone polymer is formed by extrusion, injection molding, or compression molding. Any extrusion, injection molding, or compression molding system is envisioned to provide the first portion. The silicone polymer is typically in liquid form at room temperature prior to cure, however, any processing conditions are envisioned to deliver the uncured silicone polymer to the extrusion system, injection molding system, or compressing molding system. In an exemplary embodiment, the method of providing the silicone polymer is in the absence of any solvent.

After delivery of the uncured silicone polymer, the silicone polymer of the first portion is crosslinked, i.e. cured, at a temperature lower than the heat deformation temperature of the thermoplastic polymer. In a more particular embodiment, the first portion is cured thermally at a temperature of less than about 500° F., such as less than about 400° F., such as less than about 350° F., or even less than about 80° F., via a radiation source, or combination thereof. Any reasonable radiation source is envisioned, such as actinic radiation. In an embodiment, the radiation source is ultraviolet light (UV). Any reasonable wavelength of ultraviolet light is envisioned. In a specific embodiment, the ultraviolet light is at a wavelength of about 10 nanometers to about 500 nanometers, such as a wavelength of about 200 nanometers to about 420 nanometers. Further, any number of applications of radiation energy may be applied with the same or different wavelengths. For example, one or more ovens (e.g. infrared (IR) ovens, air ovens), one or more baths (e.g. water baths), or a combination thereof, may be used to cure the silicone polymer. The one or more IR ovens can operate at a particular peak wavelength. In certain instances, the peak wavelength of a first IR oven can be different from the peak wavelength of a second IR oven. In an embodiment, the silicone polymer can be subjected to a heat treatment for a specified period of time. In a particular embodiment, the silicone polymer can be subjected to curing in a first IR oven for a first period of time and then subject to curing in a second IR oven for a second period of time that is different from the first period of time. In one particular embodiment, use is made of a short wavelength IR oven. By short wavelength, it is meant that the peak wavelength is below 4 microns, typically below 3 microns, such as within a range of approximately 0.6 to 2.0 microns, such as 0.8 to 1.8 microns. Generally medium and longer wavelength IR ovens are characterized by a peak wavelength on the order of 4 to 8 microns, or even higher. It will be appreciated that the wavelength can be within a range between any of the minimum and maximum values noted above.

Further, the second portion is provided by any reasonable means such as extrusion, injection molding, or compression molding. Any extrusion, injection molding, or compression molding system is envisioned to provide the second portion and may be the same or different system than what is used to form the first portion. In an exemplary embodiment, the thermoplastic polymer and functional moiety may be melt processed by dry blending or compounding. The dry blend may be in powder, granular, or pellet form. In an exemplary embodiment, the method of providing the thermoplastic polymer and functional moiety is in the absence of any solvent. In a particular embodiment, to form the second portion of the article, pellets of the corresponding monomer or polymer and functionalized filler may be compounded into compound pellets. The second portion may be made by a continuous compounding process or batch related process. In an embodiment, the resulting pellets are melted at a temperature less than the glass transition temperature of the thermoplastic polymer and fed into an extruder or a mold. The thermoplastic polymer and functional moiety forms the second portion of the article. In an embodiment, the second portion is directly in contact with the first portion of the article.

After the second portion is provided, the second portion may be surface treated on a surface that is adjacent to the first portion. The surface treatment may be used to increase the adhesion of the first portion to the second portion. In a particular embodiment, the surface treatment enhances the adhesion between the two portions. The surface treatment may include radiation treatment, chemical etch, physical-mechanical etch, plasma etch, corona treatment, chemical vapor deposition, blown ion treatment, or any combinations thereof.

Radiation treatment includes, for example, irradiating the surface of the second portion with any ultraviolet energy sufficient to substantially increase the adhesion of the first portion to the second portion, compared to a surface that has not been irradiated. In an embodiment, the ultraviolet energy is centered at a wavelength of about 10 nanometers (nm) to about 420 nm. It will be appreciated that the wavelength can be within a range between any of the minimum and maximum values noted above.

In an embodiment, chemical etch includes sodium ammonia and sodium naphthalene. Physical-mechanical etch may include sandblasting and air abrasion. In another embodiment, plasma etching includes reactive plasmas such as hydrogen, oxygen, acetylene, methane, and mixtures thereof with nitrogen, argon, and helium. Corona treatment may include reactive hydrocarbon vapors, such as acetone. In an embodiment, chemical vapor deposition includes the use of acrylates, vinylidene chloride, or acetone. In an embodiment, the surface of the second portion is free of any surface treatment. In another embodiment, a surface of the first portion is free of any surface treatment.

In an embodiment, the functionalized filler and/or the functional thermoplastic polymer is crosslinked to the silicone polymer. Any crosslinking conditions are envisioned, such as thermal crosslinking, radiation crosslinking, or combination thereof. In a more particular embodiment, the thermally crosslinking is at a temperature of less than the heat deformation temperature of the thermoplastic polymer, such as less than about 350° F. In a particular embodiment, the radiation source is sufficient to substantially crosslink the functionalized filler and/or the functional thermoplastic polymer to the silicone polymer of the first portion. Any reasonable radiation source is envisioned such as actinic radiation. In an embodiment, the radiation source is ultraviolet light (UV). In a particular embodiment, crosslinking includes irradiating with ultraviolet energy with a wavelength of about 10 nanometers (nm) to about 410 nm. Further, any number of applications of radiation energy may be applied with the same or different wavelengths. For example, one or more ovens (e.g. infrared (IR) ovens, air ovens), one or more baths (e.g. salt water baths), or a combination thereof, may be used. The one or more IR ovens can operate at a particular peak wavelength. In certain instances, the peak wavelength of a first IR oven can be different from the peak wavelength of a second IR oven. In an embodiment, the thermoplastic polymer can be subjected to a heat treatment for a specified period of time. In a particular embodiment, the second portion can be subjected to crosslinking in a first IR oven for a first period of time and then subject to crosslinking in a second IR oven for a second period of time that is different from the first period of time. In one particular embodiment, use is made of a short wavelength IR oven. By short wavelength, it is meant that the peak wavelength is below 4 microns, typically below 3 microns, such as within a range of approximately 0.6 to 2.0 microns, such as 0.8 to 1.8 microns. Generally medium and longer wavelength IR ovens are characterized by a peak wavelength on the order of 4 to 8 microns, or even higher. It will be appreciated that the wavelength can be within a range between any of the minimum and maximum values noted above.

Although the second portion is described in this embodiment as being delivered after the first portion is provided, any order of delivery of the polymeric components, the radiation source, thermal sources or combination thereof is envisioned. In a particular embodiment, the first portion is formed prior to the formation of the second portion. In an alternative embodiment, the second portion is formed prior to the formation of the first portion. In yet another embodiment, the first portion and the second portion are formed concurrently. In a particular embodiment, the first portion and the second portion are co-extruded, with a radiation source applied to both the first portion and the second portion simultaneously. In a more particular embodiment, the radiation source applied to both the first portion and the second portion cures the silicone polymer of the first portion at a temperature less than the heat deformation temperature of the thermoplastic polymer and crosslinks the functional moiety of the functionalized filler and/or the functional thermoplastic polymer of the second portion to form a chemical bond between the second portion and the silicone polymer of the first portion.

Once the first portion and the second portion are formed, the article can undergo one or more post processing operations. Any reasonable post processing operations are envisioned. For instance, the article can be subjected to any reasonable radiation source such as UV radiation, e-beam radiation, gamma radiation, and the like. Further, the article can be subjected to a post-cure heat treatment, such as a post-curing cycle. Post thermal treatment typically occurs at a temperature of about 104° F. (40° C.) to about 392° F. (200° C.). In an embodiment, the post thermal treatment is at a temperature of about 60° C. to about 100° C. Typically, the post thermal treatment occurs for a time period of about 5 minutes to about 10 hours, such as about 10 minutes to about 30 minutes, or alternatively about 1 hour to about 4 hours. It will be appreciated that the post thermal treatment temperature and time can be within a range between any of the minimum and maximum values noted above. In an alternative example, the article is not subjected to a post thermal treatment.

Any dimensions of the first portion and the second portion of the article are envisioned. For instance, any thickness of the portions is envisioned and is typically dependent upon the final properties desired for the article.

Once formed and cured, particular embodiments of the above-disclosed method advantageously exhibit desired properties such as increased productivity and an improved article. In a particular embodiment, the silicone polymer and thermoplastic polymer including the functional moiety that forms a chemical bond with the silicone polymer can form an article that is not achieved by conventional manufacturing processes. Lower temperature processing can be used such that a myriad of lower temperature thermoplastic polymers can be used. Further, the addition of the functionalized filler and/or the functional thermoplastic polymer provides desirable adhesion between two dissimilar materials.

Furthermore, when radiation is applied to the article, the final product has increased adhesion of the first portion and the second portion, compared to an article that is conventionally heat cured. “Conventional heat cure” is defined as a temperature of cure greater than about 350° F. Although not being bound by theory, it is believed that the radiation provides instant penetration of the radiation into at least the functionalized filler and/or the functional thermoplastic polymer and curing of the at least silicone polymer concurrently. This radiation at least crosslinks the functional moiety of the functionalized filler and/or the grafted functional group on the thermoplastic polymer or the functionalized thermoplastic copolymer, to the silicone polymer resulting in enhanced adhesive properties of the second portion to the first portion. In a more particular embodiment, the radiation provides crosslinking of the functional moiety of the thermoplastic polymer to the silicone polymer such that a cohesive bond is provided between the second portion and the first portion. In an embodiment, the adhesive strength can be enhanced with a post-thermal treatment. For instance, the first portion and the second portion of the article have a peel strength that exhibits cohesive failure, when tested in a parallel peel configuration at room temperature. In an embodiment, desirable adhesion may be achieved without a primer, a chemical surface treatment, a mechanical surface treatment, or any combination thereof between the first portion and the second portion. Furthermore, the radiation curing provides a faster cure compared to conventional thermal cure.

Once formed and cured, particular embodiments of the above-disclosed article advantageously exhibit desired properties such as adhesion strength, oxygen permeation rate, chemical permeation rate, water permeation rate, chemical resistance, wettability, and biocompatibility.

Many industries utilize articles in conjunction with an apparatus for the delivery and removal of fluids. Applications are numerous where, for example, a desirable oxygen permeation rate, chemical permeation rate, pump flow rate, pump life, and/or water vapor permeation rate are desired. For instance, the article may be used in conjunction with any reasonable apparatus. An exemplary apparatus is a medical device, a pharmaceutical device, a biopharmaceutical device, a chemical delivery device, a laboratory device, a water treatment device, a document printing device, a food and beverage device, an industrial cleaning device, an automotive device, an aerospace device, an electronics device, or a fuel delivery device. Any article, profile, or film is envisioned containing at least the first portion including the silicone polymer and the second portion directly in contact with the first portion.

In an exemplary embodiment, the article is a tube. The tube has a desirable flow stability and increased lifetime. In an embodiment, the tube may have a pump life of greater than about 60 hours, such as greater than about 150 hours, or even greater than about 400 hours as measured by peristaltic pumping at 100 rpm and 0 psi backpressure. In a particular embodiment, the first portion includes an inner layer of the tube and the second portion is an outer layer of the tube. In an alternative embodiment, the second portion includes an inner layer of the tube and the first portion is an outer layer of the tube. In an example, the inner layer of the tube provides a lumen for fluid flow therethrough.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the items as listed below.

### Embodiment 1

An article including a first portion including a silicone polymer; a second portion adjacent to the first portion, wherein the second portion includes a thermoplastic polymer including a functional moiety that forms a chemical bond with the silicone polymer, wherein the functional moiety includes a functionalized filler, a functional thermoplastic polymer, or combination thereof.

### Embodiment 2

A method of forming an article, including providing a first portion including a silicone polymer; providing a second portion adjacent to the first portion, wherein the second portion includes a thermoplastic polymer including a functional moiety that forms a chemical bond with the silicone polymer, wherein the functional moiety includes a functionalized filler, a functional thermoplastic polymer, or combination thereof; and curing the first portion at a temperature lower than the heat deformation temperature of the thermoplastic polymer to form the chemical bond between the functional moiety of the second portion and the silicone polymer of the first portion.

### Embodiment 3

The article or method of forming the article of embodiments 1 or 2, wherein the functional thermoplastic polymer includes a grafted functional group on the thermoplastic polymer, a functionalized thermoplastic copolymer, or combination thereof.

### Embodiment 4

The article or method of forming the article of embodiment 3, wherein the functionalized thermoplastic copolymer includes the thermoplastic polymer copolymerized with an epoxy based compound, a polycarbodiimide based compound, a bi-cyclic-imino ether, a bi-cyclic-imino ester, a 2,2′-bis(2-oxazoline) based molecule, an isocyanate, a di-isocyanate, or a combination thereof.

### Embodiment 5

The article or method of forming the article of embodiment 4, wherein the functionalized thermoplastic copolymer includes a thermoplastic polymer co-polymerized with an ethylene copolymer and terpolymers with glycidyl methacrylate.

### Embodiment 6

The article or method or forming the article of embodiment 3, wherein the grafted functional group on the thermoplastic polymer includes an epoxy group, a vinyl alcohol, a vinyl butyrate, a vinyl chloride, a maleic anhydride, a vinyl copolymer, a methacrylate, a nucleophile, or combination thereof.

### Embodiment 7

The article or method of forming the article of embodiments 1 or 2, wherein the functionalized filler includes a silane attached to a silica filler, wherein the silane includes an acryl functional group, an epoxy functional group, a chloro functional group, or combination thereof.

### Embodiment 8

The article or method of forming the article of embodiment 7, wherein the silane includes a trimethoxysilane, a triethoxysilane, or combination thereof.

### Embodiment 9

The article or method of forming the article of embodiments 1 or 2, wherein the functionalized filler includes a silicone-hydride attached to a silica filler.

### Embodiment 10

The article or method of forming the article of embodiment 9, wherein the silicone hydride is trimethylsiloxy-terminated.

### Embodiment 11

The article or method of forming the article of any of the preceding embodiments, wherein the silicone polymer includes a liquid silicone rubber (LSR), a high consistency gum rubber (HCR), or a room temperature vulcanizing silicone (RTV).

### Embodiment 12

The article or method of forming the article of any of the preceding embodiment, wherein the silicone polymer includes a photoactive catalyst.

### Embodiment 13

The article or method of forming the article of embodiment 12, wherein the catalyst includes platinum, peroxide, or combination thereof.

### Embodiment 14

The article or method of forming the article of any of the preceding embodiment, wherein the silicone polymer further includes an adhesion promoter.

### Embodiment 15

The article or method of forming the article of embodiment 14, wherein the adhesion promoter includes a silane.

### Embodiment 16

The article or method of forming the article of any of the preceding embodiments, wherein the silicone polymer is substantially free of an adhesion promoter.

### Embodiment 17

The article or method of forming the article of any of the preceding embodiments, wherein the thermoplastic polymer has a heat deformation temperature of not greater than about 350° F.

### Embodiment 18

The article or method of forming the article of any of the preceding embodiments, wherein the thermoplastic polymer has a glass transition temperature of less than about 77° F.

### Embodiment 19

The article or method of forming the article of any of the preceding embodiments, wherein the thermoplastic polymer includes a polyester, a polyurethane, a nylon, a polyimide, a polyamide, a polyether, a polystyrene, an acrylonitrile butadiene styrene (ABS), a polybutylene terephthalate (PBT), a polyacrylic, a polyester copolymer, an ethylene vinyl alcohol (EVOH), a polyolefin, or combination thereof.

### Embodiment 20

The article or method of forming the article of embodiment 19, wherein the polyolefin includes a polypropylene, a polyethylene, a polyolefin elastomer, a metallocene polyolefin or a Zeigler-Natta polyolefin.

### Embodiment 21

The article or method of forming the article of any of the preceding embodiments, wherein the thermoplastic polymer further includes a catalyst, a crosslink promoter, or combination thereof.

### Embodiment 22

The article or method of any of the preceding embodiments, wherein the thermoplastic polymer is substantially free of a catalyst, a crosslink promoter, or combination thereof.

### Embodiment 23

The article or method of forming the article of any of the preceding embodiments, wherein the functional moiety and the silicone polymer form a cohesive bond.

### Embodiment 24

The article or method of forming the article of any of the preceding embodiments, wherein the first portion is in direct contact with the second portion.

### Embodiment 25

The article or method of forming the article of any of the preceding embodiments, wherein the second portion adjacent the first portion includes a surface that is activated with an energy.

### Embodiment 26

The article or method of forming the article of embodiment 25, wherein the energy includes blown ion, plasma, corona, or combination thereof.

### Embodiment 27

The article or method of forming of article of any of the preceding embodiments, wherein the article is a tube.

### Embodiment 28

The method of forming the article of embodiment 2, wherein the cure includes thermal treatment, radiation treatment, or combination thereof.

### Embodiment 29

The method of forming the article of embodiment 28, wherein the radiation treatment includes an ultraviolet wavelength of about 10 nanometers (nm) to about 410 nm.

### Embodiment 30

The method of forming the article of embodiment 2, wherein providing the first portion includes injection molding, extruding, or compression molding.

### Embodiment 31

The method of forming the article of embodiment 2, wherein providing the second portion includes injection molding, extruding, or compression molding.

The concepts described herein will be further described in the following examples, which do not limit the scope of the disclosure described in the claims. The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLES

### Example 1—Preparation of a Functionalized Filler

Fumed silica is weighed (about 7.75 grams) and placed in a polypropylene container. Isopropanol alcohol (IPA) at about 23.25 grams is added to the fumed silica with about 1.5 grams of a functional additive and about 0.5 grams of water. The crosslinker is a polysiloxane crosslinker with pendant and terminal silicone hydride (Si—H) groups (Si—H content of 2.91 mmoles/gram) or a silane such as a methacryloxypropyl-trimethoxysilane or 3-glycidoxypropyltrimethoxysilane. The mixture is mixed by hand to form a wet slurry. The mixture is then placed in an oven uncovered for 4 hours at about 100° C. until the silica is completely dry. The resulting filler has about 16% functional treatment by weight.

### Example 2—Preparation of a Thermoplastic with Functionalized Filler

Method A: 1 gram of filler is added to 9 grams of two different thermoplastics (a metallocene polypropylene or a metallocene polyolefin), resulting in a 1.6% functionalized filler in the thermoplastic by weight through dry blending, i.e. mixing in a solid state. The mixture pressed in a Reliable 30 Ton heated press, i.e. heated for 3-5 minutes at the melt temperature or 20° C.−50° C. above, then pressed for 1 to 3 minutes at 8 to 20 tons force. The material is molded into 6 inch by 6 inch by 2 mm plaques.

Method B: 1 gram of filler is added to 9 grams of two different thermoplastics (a metallocene polypropylene or a metallocene polyolefin), resulting in a 1.6% functionalized filler in the thermoplastic by weight though HTS blending, i.e. mixing in a melt state with a DSM mini-extruder at 190° C. for 3 minutes at 120 rotations per minute (RPM's). The material is then extruded into rod-like form with the extrudate then taken to the Reliable 30 Ton heated press using the conditions described above and molded into 6 inch by 6 inch by 2 mm plaques.

### Example 3—Preparation of Thermoplastic with a Functional Copolymer

Method A: A thermoplastic (a metallocene polypropylene or a metallocene polyolefin) having a functional copolymer, such as an ethylene-glycidyl methacrylate copolymer, is dry blended by mixing in a solid state then pressed in a Reliable 30 Ton heated press. Particular conditions include heating for 3-5 minutes then pressed for 1-5 minutes at 8 to 20 tons force. The material is molded into 6 inch by 6 inch by 2 mm plaques.

Method B: A thermoplastic (a metallocene polypropylene or a metallocene polyolefin) having a functional copolymer, such as an ethylene-glycidyl methacrylate copolymer, is prepared with HTS blending. Particular conditions include mixing in a melt state on a DSM mini-extruder at 190° C. for 3 minutes and extruded into a rod-like form. The extrudate is then taken to the Reliabel 30 Ton heated press using the conditions described above and molded into 6 inch by 6 inch by 2 mm plaques.

### Example 4—Testing of Samples

One inch wide samples of the thermoplastic are prepared. A minimum of 2 mm thickness layer (with a maximum of 4 mm) of ultraviolet silicone is added and cured for 2 minutes under ultraviolet light. Samples may be post cured at 80° C. for 1-4 hours. After the samples are allowed to cool, for a minimum of 2 hours, the samples are pulled at a constant rate and the maximum force is recorded. A Mark-10 Force Gage setup is used to test the maximum force.

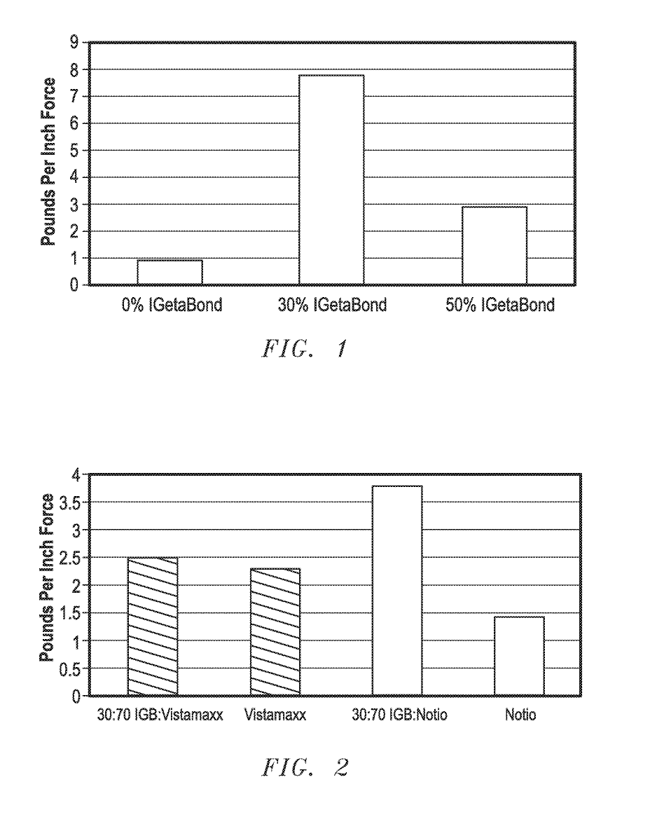

Results of the affects of the functional copolymers added to the thermoplastic polymer of Example 3 and the adhesion strength to a liquid silicone rubber (LSR) can be seen in FIGS. 1 and 2. The functional copolymer is an ethylene-glycidyl methacrylate copolymer (IGetaBond™) at 0%, 30% and 50% by weight with a metallocene polyolefin having a functional filler of fumed silica with a polysiloxane crosslinker with pendant and terminal silicone hydride (Si—H) groups (Si—H content of 2.91 mmoles/gram). The liquid silicone rubber includes a methyacryloxypropyl-trimethoxysilane. All samples had a corona treatment of the thermoplastic surface layer in direct contact with the liquid silicone rubber.

In FIG. 2, the functional copolymer is an ethylene-glycidyl methacrylate copolymer at 30% by weight in a thermoplastic such as a metallocene polyolefin (Vistamaxx™) or a metallocene polypropylene (Notio™). The thermoplastic includes a functional filler of fumed silica with methyacryloxypropyl-trimethoxysilane. The liquid silicone rubber does not include a silane. Further, a methyl-isobutyl primer is used between the thermoplastic layer and the liquid silicone layer. All samples had a corona treatment of the thermoplastic surface layer in direct contact with the liquid silicone rubber.

Tables 1 and 2 show the results of functionalized filler of a fumed silica functionalized with one of the below silane or siloxane added to a polypropylene (Table 1) or a polyethylene (Table 2) to the adhesion strength of the thermoplastic to a liquid silicone rubber (LSR). All samples had a corona treatment of the thermoplastic surface layer in direct contact with the liquid silicone rubber.

TABLE 1

| | Maximum | Percent |
|---|---|---|
| Functional filler | Pounds Force | change |
| None | 7 | — |
| 2,4,6,8-tetramethyl-2,4,6,8- | 14.9 | 113% |
| tetravinylcyclotetrasiloxane (#1) | | |
| 3-glycidoxypropyltrimethoxysilane (#2) | 15.9 | 127% |
| Methacryloxypropyl-trimethoxysilane (#3) | 25.3 | 261% |
| Trifluoropropylmethylsiloxane FMV-4031 | 21.4 | 206% |
| (#4) | | |
| Polysiloxane crosslinker with pendant and | 27.5 | 293% |
| terminal Si—H groups (2.91 mmole/g Si—H) | | |
| (#5) | | |
| Chloropropyltriethoxysilane (#6) | 20.3 | 190% |
| Dimethyoxymethylvinylsilane (#7) | 20.5 | 193% |

Adding the functional filler increases the adhesion of polypropylene to liquid silicone rubber by a minimum of 113% and a maximum of 260%.

TABLE 2

| | Maximum |
|---|---|
| | Pounds |
| Functional Filler | Force |
| None | 0 |
| Polysiloxane crosslinker with pendant and terminal Si—H | 8.3 |
| groups (2.91 mmole/g Si—H) | |
| Methacryloxypropyl-trimethoxysilane | 12.7 |
| Trimethylsilyl-terminated polymethylhydrosiloxane/ | 5.4 |
| Methacryloxypropyl-trimethoxysilane (at what ratio) | |
| Trimethylsilyl-terminated polymethylhydrosiloxane | 5.6 |

As seen in Table 2, functionalized filler is clearly shown to provide a significant increase in the ability for enabling silicone to bond to inert thermoplastics. The amount of bonding can vary depending on the chemistries used.

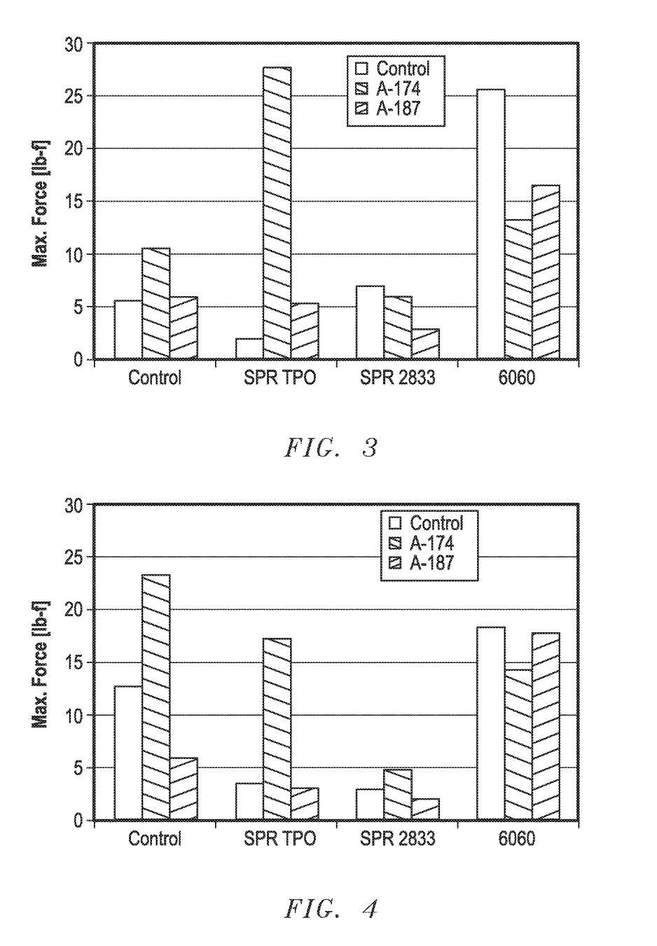

FIG. 3 shows adhesion results for metallocene polyolefin having a functionalized filler of fumed silica with methyacryloxypropyl-trimethoxysilane. The metallocene polyolefin layer is surface treated with plasma. The “control” in the legend is a liquid silicone rubber without any primer, “A-174” is methacryloxypropyl-trimethoxysilane added to the liquid silicone rubber, and “A-187” is 3-glycidoxypropyltrimethoxysilane added to the liquid silicone rubber. The adhesion is tested without a primer between the metallocene polymer layer and the LSR layer (“control” on the x-axis), and with three different primer systems: SPR TPO (a mixture of a parachlorobenzotrifluoride, xylene and ethyl benzene), SPR 2833 (mixture of naphtha solvent, ethyl silicate, and tetrabutyl titanate), and Dow Corning 6060 (methyl-isobutyl ketone).

FIG. 4 shows adhesion results for metallocene polyolefin having a functionalized filler of fumed silica with a polysiloxane crosslinker with pendant and terminal SiH groups (SiH content of 2.91 mmole/g). The metallocene polyolefin layer is surface treated with plasma. The “control” in the legend is a liquid silicone rubber without any primer, “A-174” is methacryloxypropyl-trimethoxysilane added to the liquid silicone rubber, and “A-187” is 3-glycidoxypropyltrimethoxysilane added to the liquid silicone rubber. The adhesion is tested without a primer between the metallocene polymer layer and the LSR layer (“control” on the x-axis), and with three different primer systems: SPR TPO (a mixture of a parachlorobenzotrifluoride, xylene and ethyl benzene), SPR 2833 (mixture of naphtha solvent, ethyl silicate, and tetrabutyl titanate), and Dow Corning 6060 (methyl-isobutyl ketone).

The contact angle of the thermoplastic polymer is measured using a goniometer by ASTM D7334-08 to determine if the functional filler changes the surface properties. Results can be seen in Table 3.

TABLE 3

| | | Contact angle |
|---|---|---|
| Material | Treatment | (°) |
| Polypropylene | None | 93 |
| Polypropylene | Ultraviolet | 68.6 |
| | (2 minutes) | |
| Polypropylene | Corona | 44 |
| Polypropylene | Flame | 64.1 |
| Polypropylene with filler #1 | None | 87.2 |
| Polypropylene with filler #2 | None | 77.4 |
| Polypropylene with filler #3 | None | 98 |
| Polypropylene with filler #4 | None | 94.8 |
| Polypropylene with filler #5 | None | 93.9 |
| Polypropylene with filler #6 | None | 81.7 |
| Polypropylene with filler #7 | None | 96.2 |
| Polypropylene with methacryloxypropyl- | None | 98.5 |
| trimethoxysilane | | |
| Propylene with | None | 100.6 |
| dimethoxymethylvinylsilane | | |

As seen in Table 3, the addition of the filler does not substantially change the contact angle, which indicates that the surface properties of the thermoplastic material are not substantially changed. This is in contrast to the other methods to increase bonding between two surfaces such as ultraviolet treatment, corona treatment, and flame treatment.

### Example 5

The silicone material used is a 30 durometer UV curable liquid silicone rubber (LSR) kit (commercially available from Momentive, LSR2030). The silane investigated is commercially available from Andisil, A-174, and is a methacryloxypropyl-trimethoxysilane.

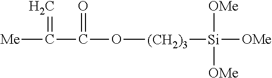

The thermoplastics investigated is a metallocene olefin (commercially available as Vistamaxx 3000), and an ethylene-vinyl acetate-glycidyl methacrylate copolymer (commercially available from Sumitomo, IGETABOND™). The ethylene-vinyl acetate-glycidyl metacrylate copolymer is 12% by weight glycidyl methacrylate and 5% by weight vinyl acetate. Example 6

Plasma treatment on permutations of metallocene olefin, functionalized filler (XL-200; a trimethyl silyl terminated, dimethyl siloxane-methyl hydrogen siloxane copolymer), and functional polyolefin are investigated. Table 4 below shows the full approach taken.

TABLE 4

| | | Plastic | | | |
|---|---|---|---|---|---|
| Set | Silicone | Side A | Plastic Side B | Functionalized | Surface |
| #1 | Side | (%) | (%) | filler (100%) | treatment |
| A | A174 | Vistamaxx | None | None | None |
| | | (100) | | | |
| B | A174 | Vistamaxx | None | None | Plasma |
| | | (100) | | | |
| C | A174 | Vistamaxx | None | XL-200 (FF) | None |
| | | (100) | | | |
| D | A174 | Vistamaxx | None | XL-200 (FF) | Plasma |
| | | (100) | | | |
| E | A174 | Vistamaxx | IGETABOND | None | None |
| | | (60) | (30) | | |
| F | A174 | Vistamaxx | IGETABOND | None | Plasma |
| | | (60) | (30) | | |
| G | A174 | Vistamaxx | IGETABOND | XL-200 (FF) | None |
| | | (60) | (30) | | |
| H | A174 | Vistamaxx | IGETABOND | XL-200 (FF) | Plasma |
| | | (60) | (30) | | |

### Example 7

The UV-curable silicone is mixed with the catalyst at a 98:2 ratio. It is a two-part addition cured reaction that is activated by UV light. The LSR is mixed with the A-174 silane at a 0.9% by weight loading. The samples are mixed in a FlackTEk DAC400.1FVZ mixer. An Enercon LM4810-17 Plasma Dyne-A-Mite VCP system is used to plasma treat the samples. The atmospheric plasma system utilizes a combination of atmospheric and argon gas at 90 and 45 psi respectively, with a flow rate of 13 standard liters per minute (slpm) during operation. The samples are under plasma for a residence time of 4 to 5 seconds per sample.

The silicone is applied to a 1-in. wide section of thermoplastic and a sapphire crystal is placed over the LSR. Force is applied until a smooth and uniform surface is obtained. The samples are then placed on a PTFE-coated fabric on top of a heat plate that is kept at 80° C. The UV light used is a 300 W UV LED from Innovation Optics that has its output wavelength centered at 365 nm and is placed directly on top of the sapphire crystal and exposed for 3 min. After the samples are removed from the sapphire crystal, they are placed in an oven for post-cure. The oven cycles up to 80° C. for 4 h to remove volatiles from the silicone. Additionally, this post cure step has been shown to increase the adhesion between the silicone and thermoplastic.

### Example 7

Several different testing are performed.

Testing results shows that it can be concluded that plasma plays a significant role increasing the peel force. Adhesion Force Testing is performed. A Mark-10 Digital Force Gauge, Series 3 is used along with a Mark-10 ES10 test stand to measure the peak force. The peak force is then recorded as the maximum adhesion force obtained.

As seen in FIG. 5, the strongest adhesion is seen with the blends of functional olefin (IGETABOND, indicated as “IGB”), functional filler, Vistamaxx and a plasma treatment. The plasma treatment increases the adhesion force in all the samples however the least variation can be noted in the final blend based on the standard error. FIG. 5 shows the dramatic increase noted from the plasma treatment working in synergy with the functional additives. Each functional additive plays a role and the blend of all with plasma has the most repeatable, strongest adhesion noted. Adhesion Results are for Vistamaxx with filler and/or IGETABOND (IGB). Peel force is shown to increase after plasma treatment.

Contact Angle is measured. Contact angle is performed on a Theta lite from Biolin Scientific by sessile drop with distilled water, and is done in accordance with ASTM D7334, Standard Practice for Surface Wettability of Coatings, Substrates and Pigments by Advancing Contact Angle Measurement.

The contact angle of the samples that had no filler in them decreased significantly post plasma treatment. The samples with functional filler however, exhibited a lesser decrease in contact angle. It is theorized that the bonding mechanism for the samples with functionalized filler is not a function of the wetting out of the silicone on the plastic substrate, as it is for the samples without. This is possibly due to plasma not having such a large effect on the functional filler in terms of surface energy.

Table 5 shows the contact angle for samples before and after plasma treatment. All silicone samples have 0.9% A174.

TABLE 5

| | | | Func- | Average | Average | |
|---|---|---|---|---|---|---|
| | | | tion- | contact | contact | |
| | Plastic | Plastic | alized | angle | angle | Change |
| Set | Material | Material B | filler | before | after | from |
| #1 | A (%) | (%) | (10%) | plasma | plasma | Plasma |
| A | Vistamaxx | None | None | 92.7 | — | 36.1 |
| | (100) | | | | | |
| B | Vistamaxx | None | None | — | 56.6 | |
| | (100) | | | | | |
| C | Vistamaxx | None | XL-200 | 91.8 | — | 89.4 |
| | (100) | | (FF) | | | |
| D | Vistamaxx | None | XL-200 | — | 2.4 | |
| | (100) | | (FF) | | | |
| E | Vistamaxx | IGETABOND | None | 89.8 | — | 25.1 |
| | (60) | (30) | | | | |
| F | Vistamaxx | IGETABOND | None | — | 64.7 | |
| | (60) | (30) | | | | |
| G | Vistamaxx | IGETABOND | XL-200 | 90.5 | — | 83 |
| | (60) | (30) | (FF) | | | |
| H | Vistamaxx | IGETABOND | XL-200 | — | 7.5 | |
| | (60) | (30) | (FF) | | | |

FTIR is performed. A Thermo Nicolet iS50 Infrared Spectrophotometer equipped with a Ge crystal ATR attachment is used. The spectrum range is set to 4000-675 cm⁻¹ with 128 scans at a resolution 4 cm⁻¹. Polystyrene is ran as a standard.

The pure Vistamaxx has an increase in the C═O stretch (1720 cm⁻¹) and the amide C═O stretch (1640 cm⁻¹) in B samples of Table 5. Amine peaks are visible in all samples as evident by the 3200-3500 cm⁻¹ peak range. This increase in functionality is a direct cause for the increase in adhesion with the silicone.

When the Vistamaxx is blended with functionalized filler and then plasma treated, FTIR shows a decrease in the alkyl stretch as well as a decrease in peaks attributed to Vistamaxx (˜1380 cm⁻¹ and 1460 cm⁻¹). This is most likely due to the plasma etching away the Vistamaxx faster than filler such as Si. This is further noted since there is an increase in peaks attributed to the silica filler, at 800, 1100, and 1540 cm⁻¹. There was also an increase in —OH groups after plasma treatment. Despite lowered alkyl stretch the net result from plasma is an increase in the adhesion which in this case may be due to the —OH functionality, or the more readily exposed functional filler.

When comparing a mix with functional olefin before and after plasma treatment, a decrease in carboxylic acid C═O stretching is noted as well as an increase in amide C═O stretching. There is also an increase in the amine stretch at 3200-3500 cm⁻¹ in the plasma treated sample. Since the olefin already has some of the functionality noted in the FTIR results, it would be expected to see such a decrease. However it should be noted that there was still an increase in the adhesion.

Lastly, when comparing blends with alpha olefin, filler, and functional olefin; an increase in silica and amide peaks is noted after plasma treatment. There is a distinct possibility that the amide C═O stretching is actually from the silica filler. Thus the same conclusion could be drawn from the prior samples with filler in that the plasma is most likely etching away the thermoplastic at a higher rate than the filler causing for an increase in the filler peaks.

XPS experiments are performed using a Physical Electronics VersaProbe II instrument equipped with a monochromatic Al kα x-ray source (hv=1,486.7 eV) and a concentric hemispherical analyzer. Charge neutralization is performed using both low energy electrons (<5 eV) and argon ions. The binding energy axis is calibrated using sputter cleaned Cu foil (Cu 2p_{3/2}=932.7 eV, Cu 2p_{3/2}=75.1 eV). Peaks are charge referenced to CHₓ band in the carbon is spectra at 284.8 eV. Measurements are made at a takeoff angle of 45° with respect to the sample surface plane. This resulted in a typical sampling depth of 3-6 nm (95% of the signal originated from this depth or shallower). Quantification is done using instrumental relative sensitivity factors (RSFs) that account for the x-ray cross section and inelastic mean free path of the electrons.

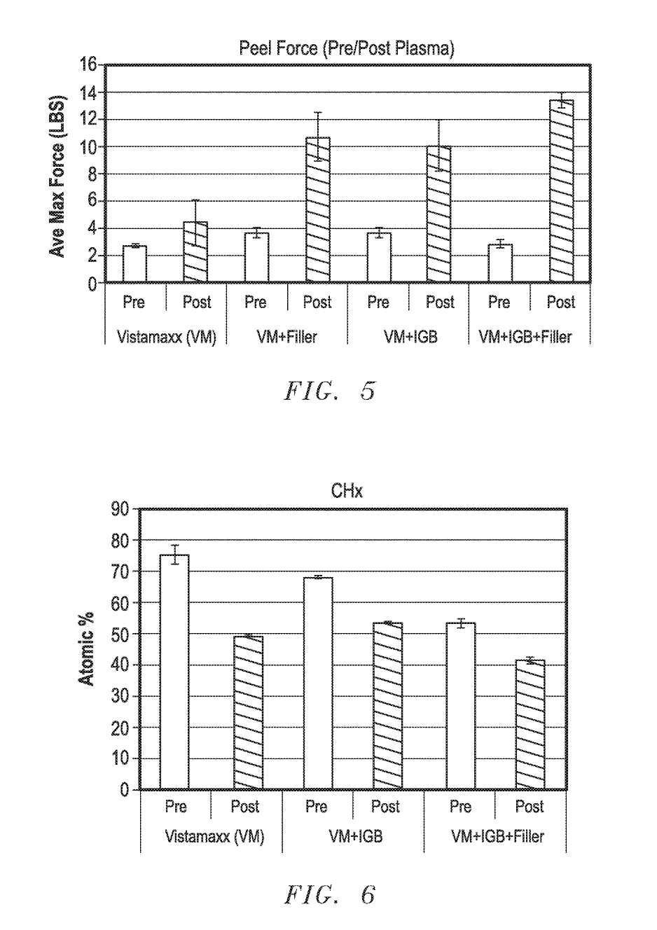

In all cases, the surface carbon content (CHₓ) is reduced while the oxygen species content increased after the argon plasma treatment as seen in FIG. 6. Most of the plots follow very similar trends where the C═O, O—C═O, and O all see increases in content after plasma treatment however the samples with functional filler see slightly less of an increase of these moieties.

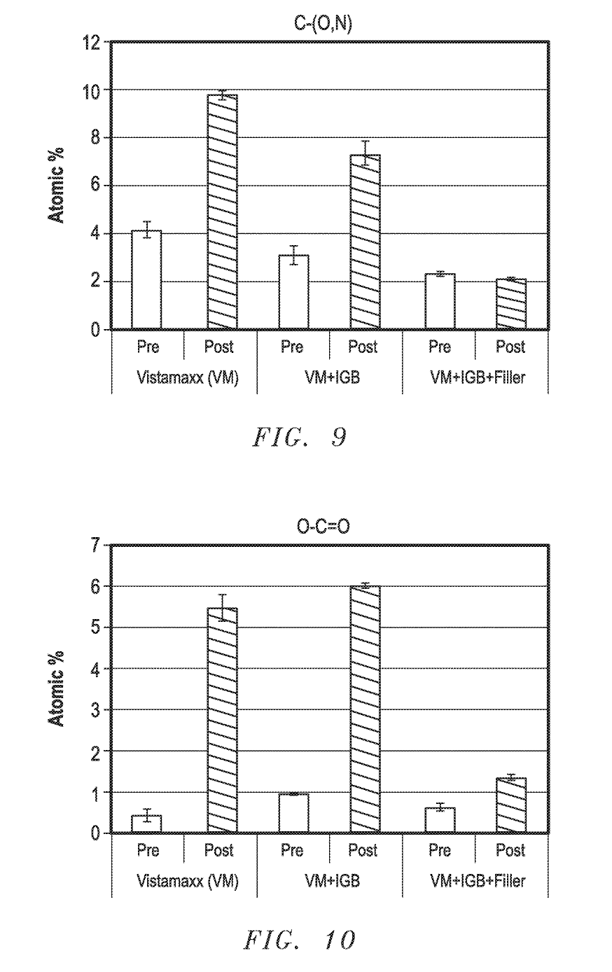

Additionally, the surface oxygen content (C═O) increases in all cases post plasma treatment as shown in FIG. 7. The nature of functional moieties generated post plasma treatment depends on what the surface chemistry of the beginning material. In the case of neat Vistamaxx, there is evidence of high amide group formation on the surface after the plasma treatment while the Vistamaxx blend containing additional functional filler remain largely unaffected as shown in FIG. 9.

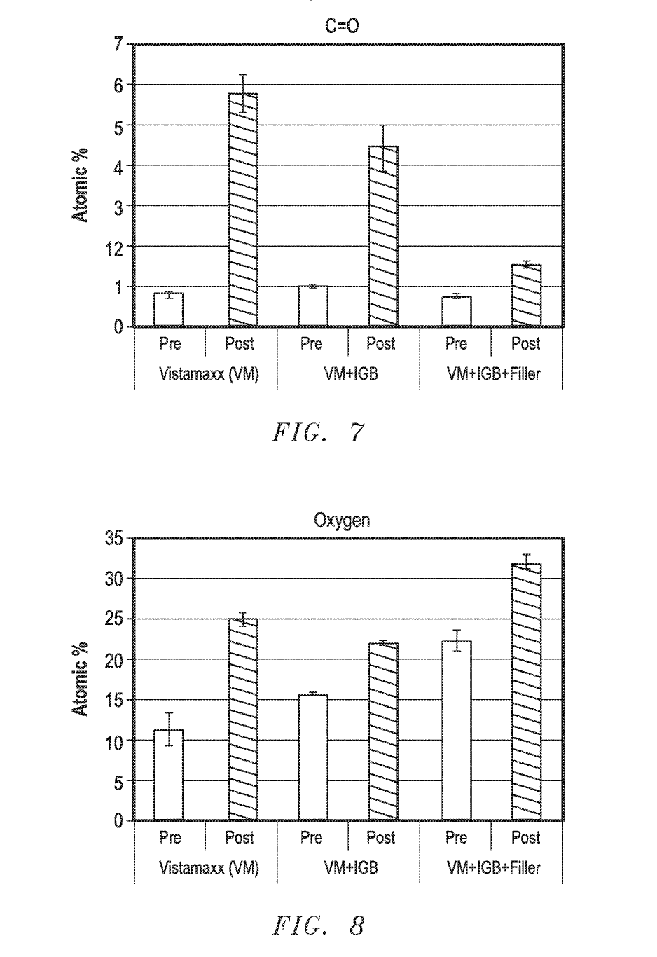

In samples where functional filler is added there appears to be less of a C═O increase as compared to the samples without filler. This is noted in FIG. 6 and can possibly be attributed to the decreased polymer surface available for plasma treatment in relation to the unfilled material. Plasma still plays the most significant role in the change of this surface chemistry, as seen in FIG. 7 and FIG. 8.

Much like the phenomena seen with Oxygen, the O—C═O content increases after plasma treatment, as shown in FIG. 10, Again we see that the plasma treatment plays the largest role in this surface change while the filler and functional olefin play less of a role.

Differential Scanning calorimetry is measured. The plasma-treated surfaces are carefully shaved with a razor and only the treated surface is collected. All data is obtained on the TA Instruments Q2000 Differential Scanning calorimeter. The system equilibrates at −50° C. and ramps to 200° C. at 5° C. per min. It holds for 1 min. and then ramps back down to −50° C. at the same rate before ramping back to 200° C. and ending the test cycle.

The plasma treatment does not alter the Tₘ or T_{c} of the samples. However, the heat of fusion decreases by around 20% for each sample. The greatest decrease in heat of fusion is in the pure Vistamaxx samples which saw a nearly 25% decrease, however all the samples displayed this phenomena to some extent. Results can be seen in Table 6.

TABLE 6

| | Heat of | Difference between untreated & |
|---|---|---|
| Samples | Fusion (J/g) | plasma treated sample (J/g) |
| 1A (not treated) | 26.5 | 6.5 |
| 1B (plasma treated) | 20.0 | |
| 1C (not treated) | 23.4 | 4.6 |
| 1D (plasma treated) | 18.8 | |
| 1E (not treated) | 22.9 | 5.1 |
| 1F (plasma treated) | 17.8 | |
| 1G (not treated) | 21.2 | 4.8 |
| 1H (plasma treated) | 16.4 | |

It can be conclusively determined that plasma treating thermoplastic polyolefins is an effective method to increase the bonding with silicone. The mechanisms of such are done by reducing the carbon content on the surface of the samples and replacing it with predominantly oxygen species. In addition the crystallinity of the plastics decreases even in cases where the plastic would be considered semi-crystalline to begin with. Some additional species may have an effect on bonding, such as adding in functionalized species into the thermoplastic. The crystallinity is affected by plasma treatment as well, and is most likely the result of surface crosslinking in the amorphous phase.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An article comprising:
a first portion comprising a silicone polymer;
a second portion adjacent to the first portion, wherein the second portion comprises a thermoplastic polymer comprising a functional moiety that forms a chemical bond with the silicone polymer, wherein the functional moiety comprises a functionalized filler, a functional thermoplastic polymer, or combination thereof.

2. The article of claim 1, wherein the functional thermoplastic polymer comprises a grafted functional group on the thermoplastic polymer, a functionalized thermoplastic copolymer, or combination thereof.

3. The article of claim 2, wherein the functionalized thermoplastic copolymer comprises the thermoplastic polymer copolymerized with an epoxy based compound, a polycarbodiimide based compound, a bi-cyclic-imino ether, a bi-cyclic-imino ester, 2,2′-bis(2-oxazoline) based molecules, isocyanates, di-isocyanates, or a combination thereof

4. The article of claim 3, wherein functionalized thermoplastic copolymer comprises the thermoplastic polymer co-polymerized with an ethylene copolymer and terpolymers with glycidyl methacrylate.

5. The article of claim 2, wherein the grafted functional group on the thermoplastic polymer comprises an epoxy group, a vinyl alcohol, a vinyl butyrate, a vinyl chloride, a maleic anhydride, a vinyl copolymer, a methacrylate, a nucleophile, or combination thereof.

6. The article of claim 1, wherein the functionalized filler comprises a silane attached to a silica filler, wherein the silane comprises an acryl functional group, an epoxy functional group, a chloro functional group, or combination thereof.

7. The article of claim 1, wherein the functionalized filler comprises a silicone-hydride attached to a silica filler.

8. The article of claim 1, wherein the silicone polymer comprises a liquid silicone rubber (LSR), a high consistency gum rubber (HCR), or a room temperature vulcanizing silicone (RTV).

9. The article of claim 1, wherein the silicone polymer comprises a photoactive catalyst.

10. The article of claim 1, wherein the thermoplastic polymer has a heat deformation temperature of not greater than about 350° F.

11. The article of claim 1, wherein the thermoplastic polymer has a glass transition temperature of less than about 77° F.

12. The article of claim 1, wherein the thermoplastic polymer comprises a polyester, a polyurethane, a nylon, a polyimide, a polyamide, a polyether, a polystyrene, an acrylonitrile butadiene styrene (ABS), a polybutylene terephthalate (PBT), a polyacrylic, a polyester copolymer, an ethylene vinyl alcohol (EVOH), a polyolefin, or combination thereof.

13. The article of claim 12, wherein the polyolefin comprises a polypropylene, a polyethylene, a polyolefin elastomer, a metallocene polyolefin or a Zeigler-Natta polyolefin.

14. The article of claim 1, wherein the functional moiety and the silicone polymer form a cohesive bond.

15. The article of claim 1, wherein the article is a tube.

16. A method of forming an article, comprising:
providing a first portion comprising a silicone polymer;
providing a second portion adjacent to the first portion, wherein the second portion comprises a thermoplastic polymer comprising a functional moiety that forms a chemical bond with the silicone polymer, wherein the functional moiety comprises a functionalized filler, a functional thermoplastic polymer, or combination thereof; and
curing the first portion at a temperature lower than the heat deformation temperature of the thermoplastic polymer to form the chemical bond between the functional moiety of the second portion and the silicone polymer of the first portion.

17. The method of forming the article of claim 16, wherein the cure comprises thermal treatment, radiation treatment, or combination thereof.

18. The method of forming the article of claim 17, wherein the radiation treatment comprises an ultraviolet wavelength of about 10 nanometers (nm) to about 410 nm.

19. The method of forming the article of claim 16, wherein the second portion adjacent the first portion comprises a surface that is activated with an energy.

20. The method of forming the article of claim 19, wherein the energy comprises blown ion, plasma, corona, or combination thereof.
